(19) United States
(12) Patent Application Publication
(10) Pub. No.: US 2003/0103637 A1
(43) Pub. Date: Jun. 5, 2003

(54) Headphone

(76) Inventor: Jui-Shu Huang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/000,505

(22) Filed: Dec. 4, 2001

(51) Int. Cl. H04R 5/02; H04R 25/00

(52) U.S. Cl. 381/309; 381/74; 381/371

(57) ABSTRACT

The present invention relates to a headphone with two ear cups each of which includes a loudspeaker or a plurality of multichannel speakers. Each speaker has its own individual sound chamber. In accordance with the feature of the speakers, they are installed at the front or rear sides of the individual sound chambers. Accordingly, each speaker is arranged inside the ear cup at different places or angles, thereby creating a clear sound field, protecting against the mixture of the sound waves and reducing the distortion. Beside, a well-distributed sound pressure is formed inside each individual sound chamber. Again, the surround sound effect is enhanced to achieve the original sound quality with high fidelity.

### BACKGROUND OF THE INVENTION

1. Field of the Invention

The present invention relates to a headphone, and more particularly, to a headphone with an ear cup in which a loudspeaker or several multichannel speakers are provided. Each speaker includes an individual sound chamber according to its sound feature and is located at different place of the sound chamber.

2. Description of the Prior Art

With the improvement of the digital technology and the popularization of the digital audio-video products like DVD players or surround amplifiers, they basically own the Dolby Digital and DTS decoding functions through which the digital signals are decoded to output the analog signals to the speaker. Therefore, DVD players or the surround amplifiers include an analog output terminal of 5.1-ch sound signals for establishing a home theater system with TV, DVD player, surround amplifier and 5.1-ch speaker.

FIG. 1 shows a perspective view of a home theater system. The DVD player or the surround amplifier (not shown) inside the cabinet (A) sends the 5.1-ch sound signals or the multichannel tone signals to the left and right speakers F(L) and F(R) of the front main channel, the center channel speaker (C) and the left and right speakers S(L) and S(R) of the rear surround channel, thereby creating an excellent audio environment.

5.1-ch or multichannel sound output brings the listeners an excellent enjoyment of the best sound effect. However, this will trouble those who are at work and don't listen to the sound. When putting on headphone, the listeners can't enjoy the multichannel surround sound effect since the conventional headphone plug (P) (see FIG. 2A) can only reach two-channel stereophonic effect and only a loudspeaker (F) is fitted to the inside of either ear cup (B). Besides, the two-channel headphone does nothing for the sound field or sound pressure so that the sound effect of the conventional two-channel headphone can't be improved.

Since the headphone is considered as attachments rather than the core of the stereo set and the profit thereof is low, only few want to invest in this field for further development. Therefore, the currently existing headphone gives only two-way original sound. The reason is that the conventional phone plug has only two or three electric poles (one of them is for earthing) so that the single plug can't transmit multichannel sound signal.

Currently, the 5.1-ch headphone is commercially available. However, this kind of product only simulates the 5.1 decoding function rather than the reproduction of the 5.1-ch original sound. In addition, a negative effect will be produced when the simulated sound is not processed well.

A multichannel phone plug P′, as shown in FIG. 2B, disclosed by the inventor of the present invention is inserted into the phone jack of the DVD players or surround amplifiers so that the multichannel sound signals can be transmitted to different loudspeakers. However, the inside of the ear cup (B) can't be provided with the front main speakers (F), the center channel speaker (C) and the rear surround speakers due to the space restriction so that the multichannel speakers can't reach the same sound effect as the home theater system shown in FIG. 1. Moreover, different channel sounds are mixed together so that the expected quality and effect of the multichannel sound effect can't be reached.

Accordingly, how to reach the high quality sound effect through the two-channel or multichannel headphone is the main topic of the present invention.

### SUMMARY OF THE INVENTION

It is a primary object of the present invention to remove the above-mentioned drawbacks and to provide a headphone with two ear cups each of which includes a plurality of multichannel speakers. Each speaker has its own individual sound chamber. In accordance with the feature of the speakers, they are installed at the front or rear sides of the individual sound chambers. Accordingly, each speaker is arranged inside the ear cup at different places or angles, thereby creating a clear sound field, protecting against the mixture of the sound waves and reducing the distortion. Beside, a well-distributed sound pressure is formed inside each individual sound chamber. Again, the surround sound effect is enhanced to achieve the original sound quality with high fidelity

It is another object of the present invention to provide a headphone with two ear cups each of which includes a loudspeaker which contains at least one individual sound chamber and enhances the two-way stereo sound effect by means that the individual sound chamber is arranged at different places.

### BRIEF DESCRIPTION OF THE DRAWINGS

The accomplishment of this and other objects of the invention will become apparent from the following description and its accompanying drawings of which:

FIG. 1 is a perspective view of the basic audio environment of a home theater system;

FIG. 2A is a perspective view of a conventional headphone;

FIG. 2B is a perspective view of another conventional headphone;

FIG. 3 is a schematic drawing of a first embodiment of the present invention;

FIG. 4 is a perspective exploded view of FIG. 3;

FIG. 5 is a sectional view of the first embodiment of the present invention;

FIG. 6 is another sectional view of the first embodiment of the present invention;

FIG. 7 is a top view of the cover of the first embodiment of the present invention with three channel speakers;

FIG. 8 is another top view of the cover of the first embodiment of the present invention with four channel speakers;

FIG. 9 is a sectional view of a second embodiment of the present invention;

FIG. 10 is a sectional view of the second embodiment of the present invention in operating condition;

FIG. 11 is a sectional view of the second embodiment of the present invention in another operating condition;

FIG. 12 is a sectional view taken along the line 12-12 of FIG. 1; and

FIG. 13 is a schematic drawing of the second embodiment of the present invention in use.

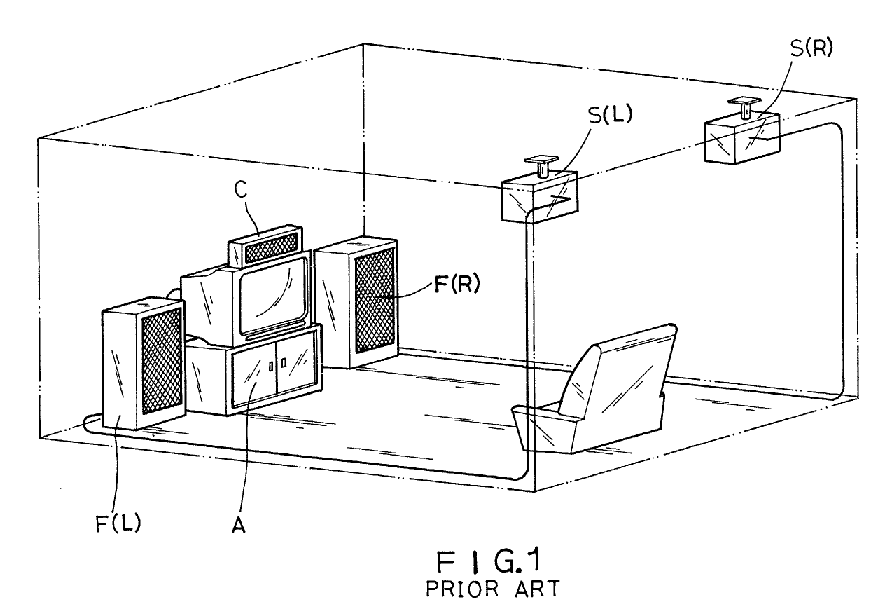

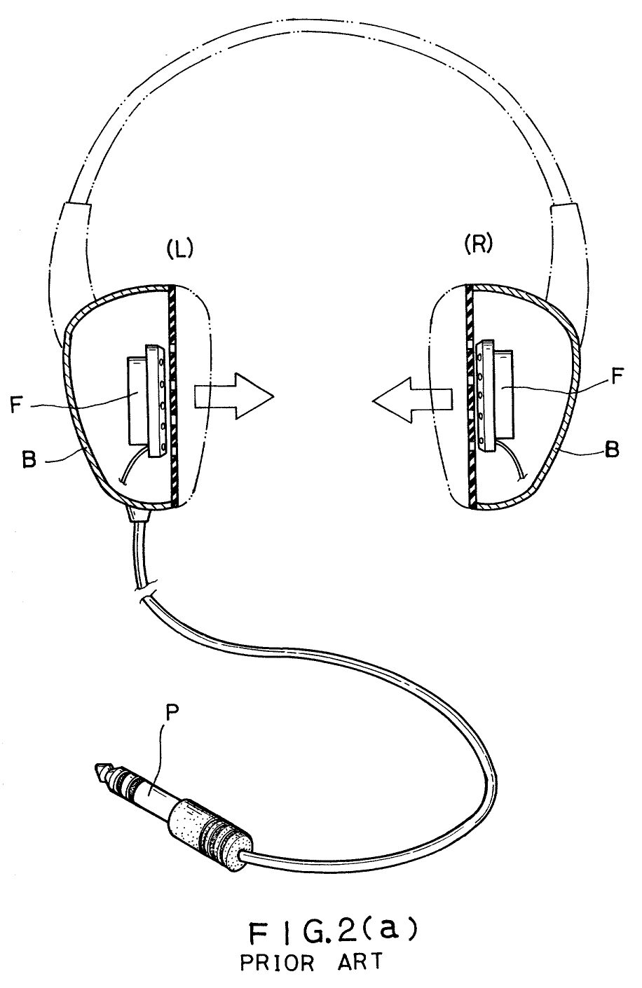

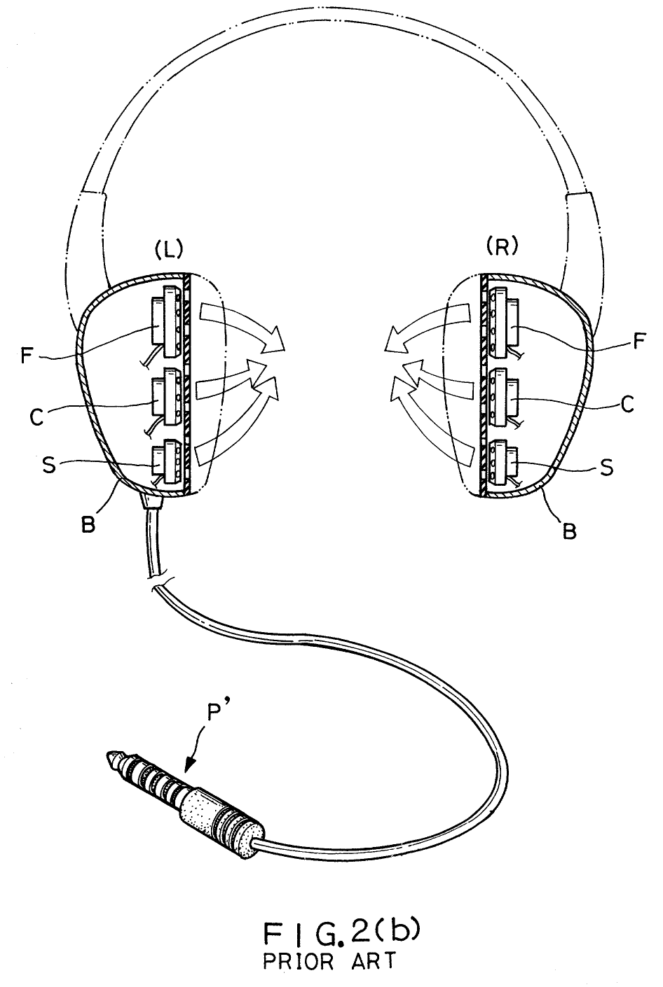

### DETAILED DESCRIPTION OF THE PREFERRED EMBODIMENT

The First Embodiment:

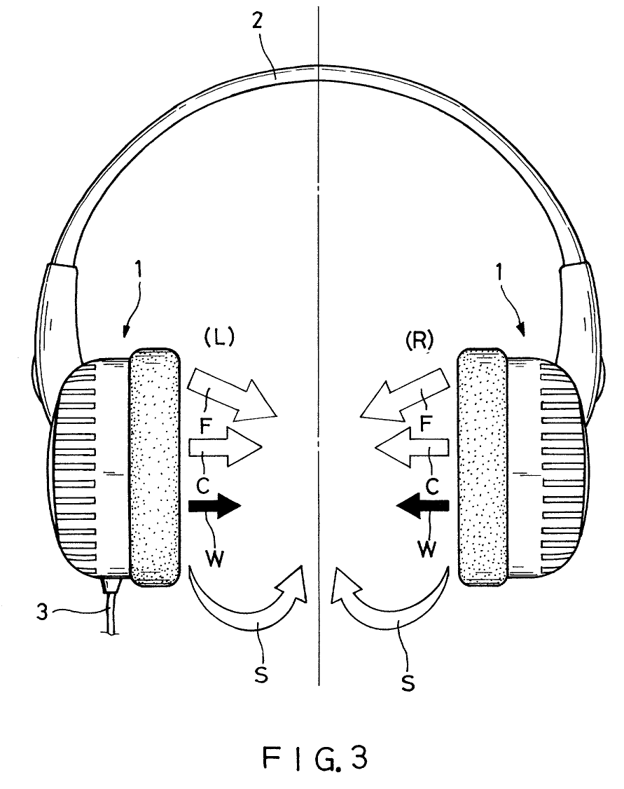

First of all, referring to FIG. 3, the headphone of the first embodiment of the present invention includes a left and a right ear cup 1, a headband 2 connecting both ear cups 1 and a cord 3 extending from one of the ear cups 1. The inside of each of the ear cups 1 is provided with several different channel speakers (not shown) for creating the multichannel sound effect while all sound channels won't be mixed with one another so that an expected multichannel sound quality is achieved.

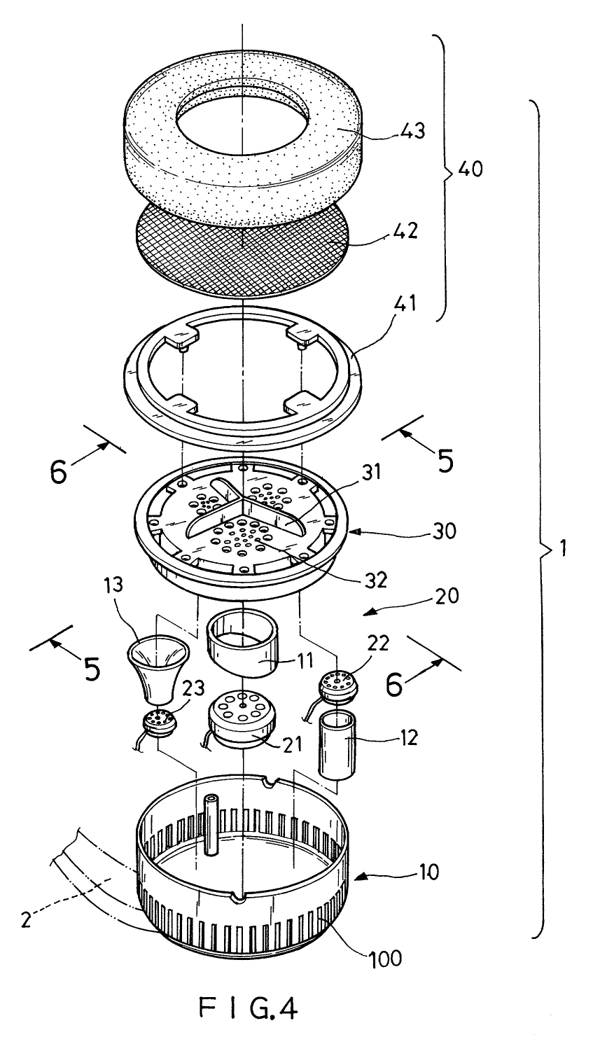

As shown in FIGS. 4 through 6, an applicable embodiment of the ear cup 1 includes a housing 10, a plurality of multichannel speakers 20, a cover 30 and a sealing set 40.

The housing 10 in preset shape contains an opening at the top thereof, a plurality of air vents 100 around the rim of the housing 10 and a number of multichannel speakers 20 received in individual sound chambers 11, 12, 13 of the housing 10, respectively.

The multichannel speakers 20 at least contains a front main speaker 21, a center channel speaker 22 and a rear surround speaker 23 three of which are arranged in their own sound chamber in accordance with the feature of speakers, respectively.

The cover 30 is disposed at the opening of the housing 10 and contains a number of partitions 31 dividing the cover 30 into several identical sections with sound output holes 32 opposite the speaker 21, 22, 23.

The sealing set 40 is mounted on the cover 30 and provided with a locating ring 41 fixed to the cover 30, a thin layer of cloth 42 attached to the locating ring 41 and covering the sound output holes 32 without adverse influence over the sound output and an ear cushion 43 covering the locating ring 41 and the thin layer of cloth 42. The ear cushion 43 is composed of soft material, such as sponge or the like, and is able to cover the ear.

The sound chambers 11, 12, 13 are formed in shape of tube, cone, or the like.

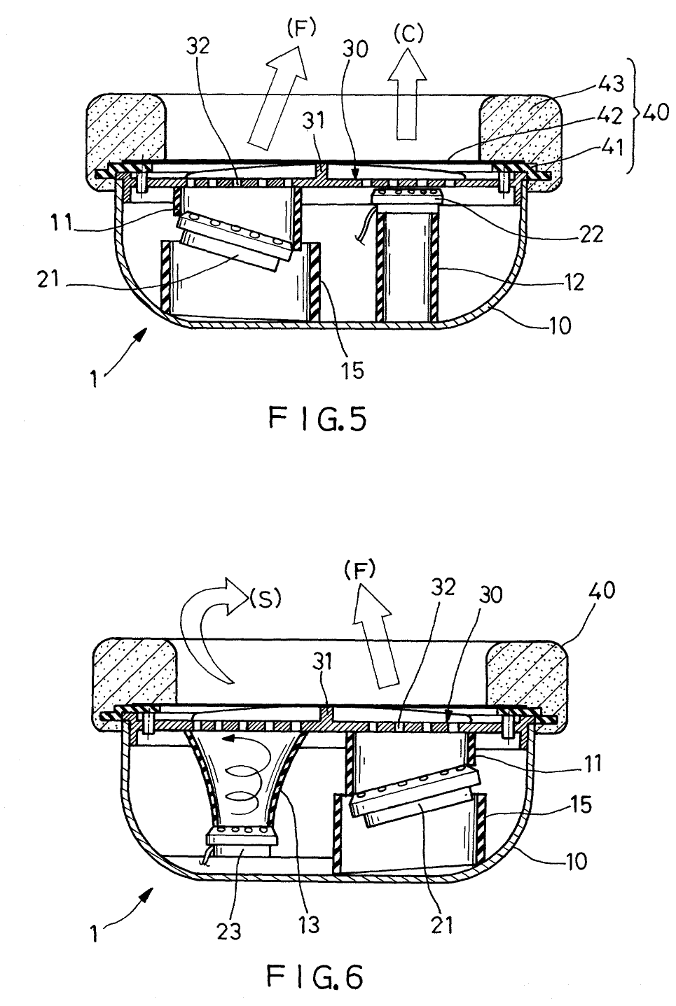

Referring to FIGS. 5 and 6, the speakers 21, 22, 23 inside the housing 10 are separated from one another by means of individual sound chambers 11, 12, 13, thereby having their own sound field. In testing the present invention, it is discovered that each speaker required different sound field in accordance with the feature and the requirement of the sound effect. It's preferable to install the center channel speaker 22 in front of the sound chambers 11 and near the sound output holes 32. The front main speaker 21 and the center channel speaker 22 require sound fields of different size. The front main speaker 21 needs a greater sound chamber 11 and is fitted to the rear end of the sound chamber 11; in addition, it's preferred that the front main speaker 21 is installed in slightly slanted way. As for the sound fields, they can be adjusted in accordance with the requirements of the products. The sound effect of the center channel speaker 22 is direct and penetrating because it is installed near the sound output holes 32. Moreover, the sound chamber 12 can protect the center channel speaker 22 from mixing with the other tone waves of the other sound channels. The front main speaker 21 is basically installed at the place slightly lower than the center channel speaker 22, and their sound output frequencies are made different in order to achieve clearer sound field. The rear surround speaker 23 is installed in the elongated sound chamber 13 so that the output of the sound wave can be delayed, thereby feeling that the sound is situated behind. Besides, after the sound passes through the sound chamber 13, a more extended surround field is created. If the mouthpiece of the rear surround speaker 23 is enlarged, the surround effect will be enhanced. In accordance with the feature of individual speakers 21, 22, 23, they are installed at the front or rear end of the sound chambers and situated at the place of different height and angle inside the ear cup 1, thereby creating their own clear sound fields, protecting against the mixture and interference of different waves and exercising their own sound features. Besides, the multichannel sound frequency and sound range are separated from one another so that the original sound is reproduced and the distortion is reduced, thereby achieving the hi-fi and three-dimensional accurate sound effect.

The form and the size of the sound chambers 11, 12, 13 can be made in accordance with the specification of the headphone. The sound chambers 11, 12, 13 shown in FIGS. 4 through 6 is only an applicable embodiment of the present invention. In the reality, the form thereof is adjustable to get the balance of the sound range of each sound channel. Furthermore, each of the sound chambers 11, 12, 13 can be directly combined inside the housing 10 in a body.

The sound delivered by the speakers 21, 22, 23 through the sound output holes 32 can be separated by the partitions 31 on the surface of the cover 30, thereby reducing the sound interference and reproducing a clearer and more detailed music so that the listener can enjoy a multichannel sound effect with a more excellent quality.

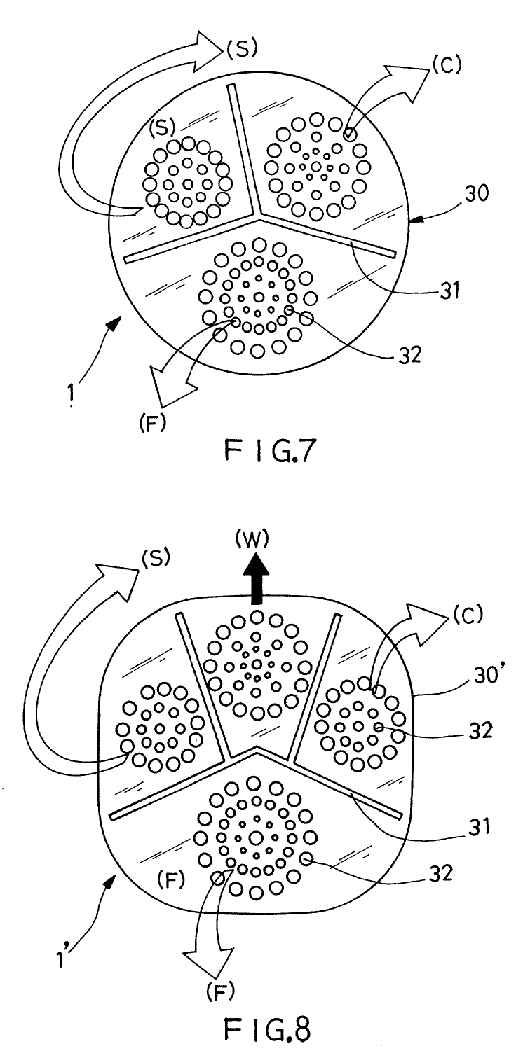

FIG. 7 shows a top view of the cover 30 of the above-mentioned embodiment. Three speakers (not shown) are provided inside the cover 30, thereby reproducing the front main channel sound effect (F), the center sound effect (C) and the surround sound effect (S). The ear cup 1 can be not only in the round form, but also in non-cylindrical form, as shown in FIG. 8. In addition to the above three sound channels, a special sound channel, such as a woofer sound channel (W), can be added. Meanwhile, a woofer and an individual sound chamber (not shown) have to be provided to protect against the interference of the sound waves.

The Second Embodiment:

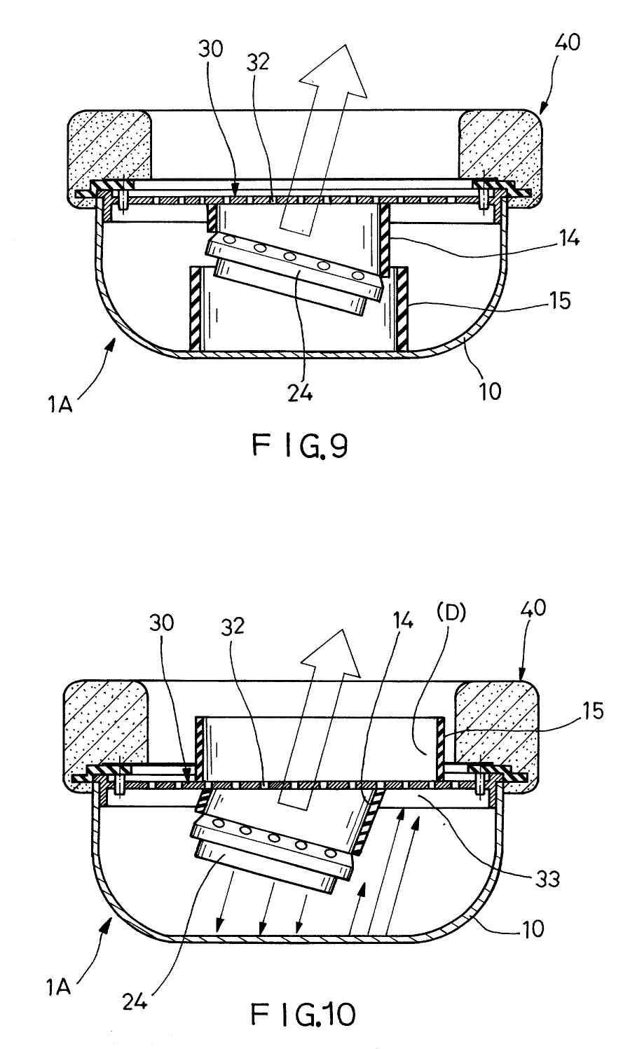

From the aforementioned embodiment, we know the significance of the individual sound chamber. The second embodiment of the present invention utilizes a loudspeaker 24 provided inside the housing 10 of either of the right or left ear cup 1A (see FIG. 9). A cover 30 and a sealing set 40 are arranged at the opening of the housing 10. The principle of the first and second embodiments of the present invention is identical. The second embodiment differs from the first embodiment in having a loudspeaker 24 provided inside the ear cup 1A.

The loudspeaker 24 is installed in a preset individual sound chamber 14 according to the feature of the single speaker and located at a preset place or angle of the ear cup 1A.

As shown in FIG. 9, the loudspeaker 24 is installed at the lower place of the individual sound chamber 14 according to the feature of the single speaker so that the sound of the loudspeaker 24 is sent out by passing through the individual sound chamber 14 and the sound output holes 32. The position of the loudspeaker 24 in the individual sound chamber 14 can change the output tone frequency. The longer the individual sound chamber 14 is, the clearer and the more vigorous the low-frequency sounds are. If the loudspeaker 24 is installed at an inclined angle of 15-20 degrees, the output sound waves won't directly hit the human ears, but linger in the ears, thereby creating a sound-expanding effect. Based on this reason, the main channel speaker 21 of the first embodiment of the present invention is also installed at inclined angle.

Furthermore, if a second sound chamber 15 is fitted behind the loudspeaker 24, the sound waves will be more condensed so that the output sound effect is more vigorous and penetrating. This second sound chamber 15 can also be provided in the main channel speaker 21 of the embodiment shown in FIGS. 5 and 6 in order to create the same sound effect if there's room enough.

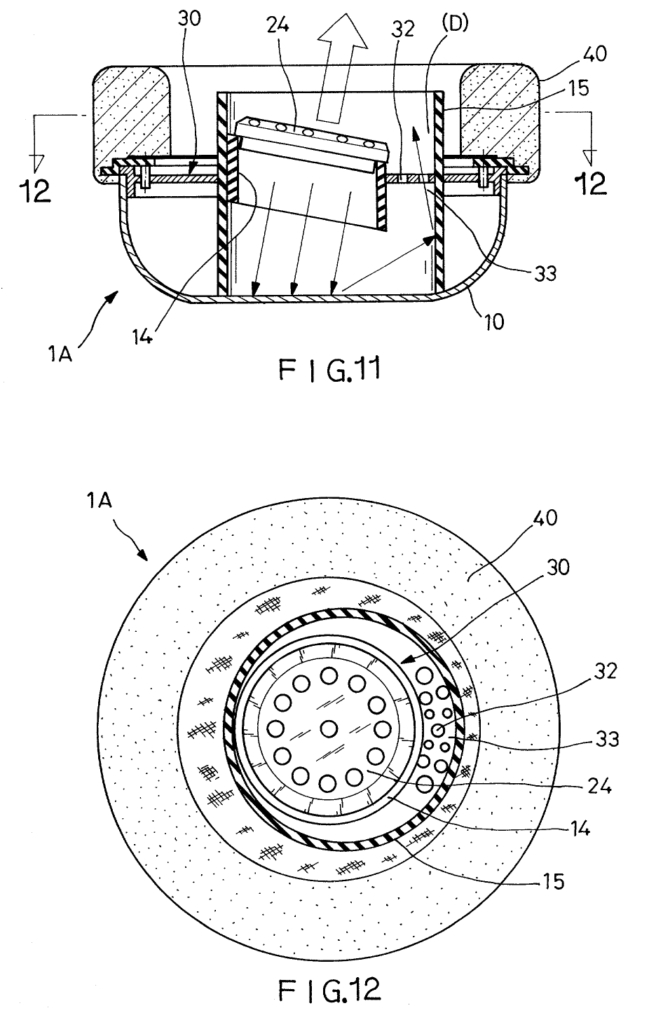

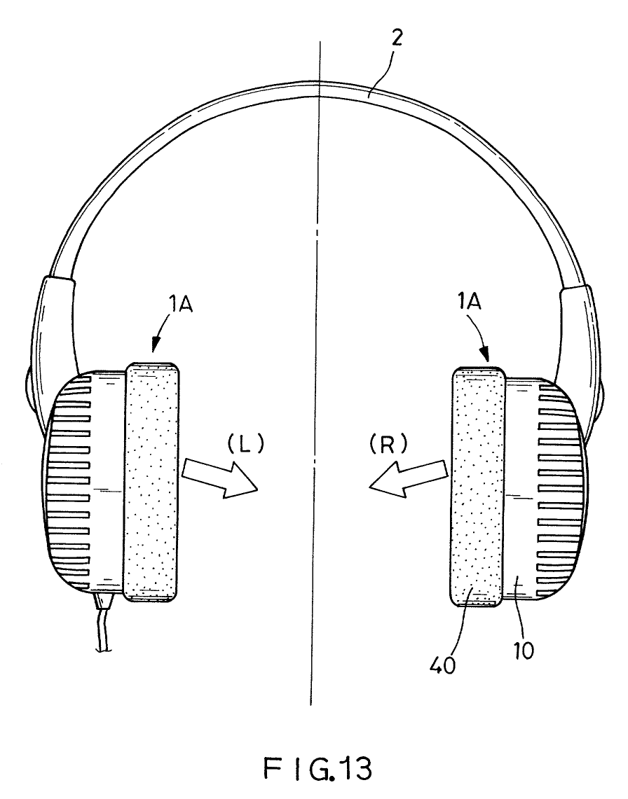

FIG. 10 shows another application state of the second embodiment in which the second sound chamber 15 is mounted on the surface of the cover 30. FIG. 11 shows a further application state of the second embodiment. In both application states, the second sound chamber 15 has a larger diameter than the individual sound chamber 14 and projects from the surface of the cover 30, thereby more approaching the ear. Moreover, as shown in FIG. 12, the second sound chamber 15 is located at one side of the individual sound chamber 14 in an eccentric way, and the eccentric area 33 contains a number of sound output holes 32. Therefore, after the front sound of the loudspeaker 24 is sent out from the front side of the individual sound chamber 14, the sound waves at the rear side thereof is reflected or linger therearound. Finally, they pass through the sound output holes 32 of the eccentric area 33 for output. Accordingly, this sound near the inner wall of the second sound chamber 15 above the eccentric area 33 and the sound sent out from the front side create a resonance area (D). This effect will be the most marked in listening to the percussion music. Thus, in the second embodiment of the present invention, as shown in FIGS. 10 through 12, the second sound chamber 15 is installed around of the individual sound chamber 14, thereby creating a form of “tube in tube”. Therefore, only a single speaker can reach an excellent sound effect. In comparison with the conventional headset, the present invention can reproduce a more condensed and penetrating sound, thereby creating stereo sounds with high fidelity.

The loudspeaker 24 is arranged atop the individual sound chamber 14 and inside the second sound chamber 15 in order to increase the resonance points. Moreover, the second sound chamber 15 can be extended to the bottom of the housing 10 so that the sound waves reflect and linger more rapidly to create another sound effect. The length and the installation way of the individual sound chamber 14 shown in FIGS. 9 through 11 are applicable, and a best installation way can be chosen in accordance with the form of the headphone in order for the loudspeaker 24 to exercise the expected effect.

FIG. 13 shows a schematic drawing of the second embodiment of the present invention in use. Each of the left and right ear cups 1A contains a two-way stereo speaker with the aforementioned individual sound chamber 14 so that the output path of the sound waves are slightly inclined in comparison with that of the conventional two-way headphone. Therefore, the room for lingering between the ear cups and the ears is available, and the individual sound chamber 14 makes sounds with stereo effect more condensed, penetrating and clear.

The above two embodiment of the present invention is based on the individual sound chamber to enhance the sound effect of the headphone, thereby reproducing clear, non-interfering and balancing original sounds. Accordingly, the present invention is provided with practicalness and progressiveness.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A headphone with two ear cups each of which comprises:
a housing in preset shape having an opening at the top thereof and a number of multichannel speakers all of which are received inside thereof and includes individual sound chambers;
a plurality of multichannel speakers at least having a front main speaker, a center channel speaker and a rear surround speaker three of which are arranged in their own sound chamber in accordance with the feature of speakers, respectively;
a cover disposed at the opening of said housing and having on the surface thereof a number of sound output holes opposite said speaker, and
a sealing set mounted on said cover, thereby forming a complete headset.

2. The headphone as recited in claim 1 wherein said multichannel speakers further contain a woofer.

3. The headphone as recited in claim 1 wherein said multichannel speakers are arranged inside said housing at different height or angle by means of said individual sound chambers.

4. A headphone with two ear cups each of which comprises:
a housing in preset shape having an opening at the top thereof and a loudspeaker which is received inside thereof and includes an individual sound chamber;
a loudspeaker arranged inside said preset sound chamber in accordance with the speaker's feature such that said loudspeaker is located inside said ear cup at a preset place or angle;
a cover disposed at the opening of said housing and having a number of sound output holes on the surface thereof, and
a sealing set mounted on said cover, thereby forming a complete headset.

5. The headphone as recited in claim 4 wherein said loudspeaker is installed at a preset place of said individual sound chamber at an inclined angle of 15-20 degrees.

6. The headphone as recited in claim 4 wherein said individual sound chamber is provided with a second sound chamber of a greater internal diameter at the outside thereof which is disposed at one side of said individual sound chamber in an eccentric way and projects over the surface of said cover, and wherein said eccentric area contains sound output holes.
